(19) United States
(12) Patent Application Publication
(10) Pub. No.: US 2023/0244225 A1
(43) Pub. Date: Aug. 3, 2023

(54) CONTROL APPARATUS, CONTROL METHOD AND PROGRAM

(71) Applicant: Nippon Telegraph and Telephone Corporation, Tokyo (JP)

(72) Inventors: Takuma TSUBAKI, Musashino-shi, Tokyo (JP); Ryota ISHIBASHI, Musashino-shi, Tokyo (JP); Takeshi KUWAHARA, Musashino-shi, Tokyo (JP)

(21) Appl. No.: 17/919,023

(22) PCT Filed: Mar. 12, 2021
(86) PCT No.: PCT/JP2021/010062

§ 371 Date: Oct. 14, 2022

(30) Foreign Application Priority Data
Apr. 16, 2020 (WO) PCT/JP2020/016731

(51) Int. Cl. G05D 1/00; B60W 60/00

(52) U.S. Cl. CPC G05D 1/0022; B60W 60/005; H04L 67/12

(57) ABSTRACT

A control device for controlling a moving body in a system of monitoring the moving body from a remote location via a network includes a policy database configured to store policy information for controlling the moving body, a policy information calculation unit configured to calculate policy information indicating details of control according to a quality of the network on the basis of surrounding conditions of the moving body and to store the policy information in the policy database, and a control execution unit configured to acquire the quality of the network and to execute control corresponding to the quality of the network with reference to the policy information.

### TECHNICAL FIELD

The present invention relates to a technology for controlling a moving body monitored from a remote location.

### BACKGROUND ART

In recent years, development of automatic driving vehicles has progressed. For example, level-3 and level-4 automatic driving vehicles can perform autonomous automatic driving using sensors, cameras, and the like.

However, remote monitoring and control intervention are obligatory in case autonomous driving becomes impossible due to system failure, the weather, or the like.

Therefore, there is a need for a function to reliably stop or control automatic driving vehicles from a remote location, that is, via a network (NW) as necessary. As conventional technologies for controlling a device via a network, for example, there are technologies disclosed in NPL 1 and 2.

NPL 1 discloses a technology for improving the reachability of a message (control signal) using a communication enable/disable state and a state transition frequency. In addition, NPL 2 discloses a technology for enabling remote control even in an environment with a NW delay by combining a control response (feedback) and NW delay prediction.

### CITATION LIST

### Non Patent Literature

[NPL 1] Koshiji Kohjun, et al., “Study of a network function to assist a message transmission (network system)”. IEICE technical report 118.465 (2019), 515-520.
[NPL 2] Yoshida Hiroshi, Taichi Kumagai, and Kozo Satoda, “Dynamic state-predictive control for a remote control system with large delay fluctuation”. 2018 IEEE International Conference on Consumer Electronics (ICCE), IEEE, 2018.

### SUMMARY OF THE INVENTION

### Technical Problem

An observer who monitors an automatic driving vehicle from a remote location takes some time interval to stop the vehicle even if he/she is aware of a danger. Further, if the NW quality is low, it takes some time interval for a stop instruction to reach the automatic driving vehicle even if the stop instruction is given with regard to the NW delay. Moreover, a distance from a point where the stop instruction arrives to a point where the automatic driving vehicle actually stops varies depending on the surrounding conditions of the automatic driving vehicle.

Under such circumstances, it is necessary to control the speed of the automatic driving vehicle according to the NW quality and the surrounding conditions in order to reliably stop the automatic driving vehicle within a specified stopping distance according to an instruction from a remote location. However, no conventional technology for controlling an automatic driving vehicle according to the NW quality and the surrounding conditions has been proposed. Such a problem can occur not only in automatic driving vehicles but also in moving bodies in general.

The present invention has been made in view of the aforementioned circumstances, and an object of the present invention is to provide a technology for appropriately controlling a moving body according to the network quality and surrounding conditions in a system for monitoring a moving body from a remote location via a network.

### Means for Solving the Problem

According to the disclosed technology, there is provided a control device for controlling a moving body in a system of monitoring the moving body from a remote location via a network, including a policy database configured to store policy information for controlling the moving body, a policy information calculation unit configured to calculate policy information indicating details of control according to a quality of the network on the basis of surrounding conditions of the moving body and to store the policy information in the policy database, and a control execution unit configured to acquire the quality of the network and to execute control corresponding to the quality of the network with reference to the policy information.

### Effects of the Invention

According to the disclosed technology, it is possible to appropriately control a moving body according to the network quality and surrounding conditions in a system of monitoring the moving body from a remote location via a network.

### BRIEF DESCRIPTION OF DRAWINGS

FIG. 1 is an overall configuration diagram of a system according to an embodiment of the present invention.

FIG. 2 is a diagram for describing an overview of operations.

FIG. 3 is a diagram for describing an overview of operations.

FIG. 4 is a configuration diagram of a control device in a first embodiment.

FIG. 5 is a hardware configuration diagram of the device.

FIG. 6 is a flowchart of the operation of the control device in the first embodiment.

FIG. 7 is a diagram showing an example of information to be acquired.

FIG. 8 is a diagram showing an example of information to be acquired.

FIG. 9 is a diagram showing an example of information written in a policy DB.

FIG. 10 is a diagram showing an example of acquired NW information.

FIG. 11 is a diagram for describing control in which jitter is added.

FIG. 12 is a diagram for describing TAT.

FIG. 13 is a configuration diagram of a control device in a second embodiment.

FIG. 14 is a flowchart of the operation of the control device in the second embodiment.

FIG. 15 is a diagram showing an example of information written in a policy DB.

FIG. 16 is a diagram showing an example of acquired NW information.

FIG. 17 is a diagram showing an example of acquired NW information.

### DESCRIPTION OF EMBODIMENTS

Hereinafter, embodiments of the present invention (the present embodiments) will be described with reference to the drawings. The embodiments described below are merely examples, and the embodiments to which the present invention is applied are not limited to the following embodiments. Hereinafter, the first embodiment and the second embodiment will be described.

### First Embodiment

(System Configuration)

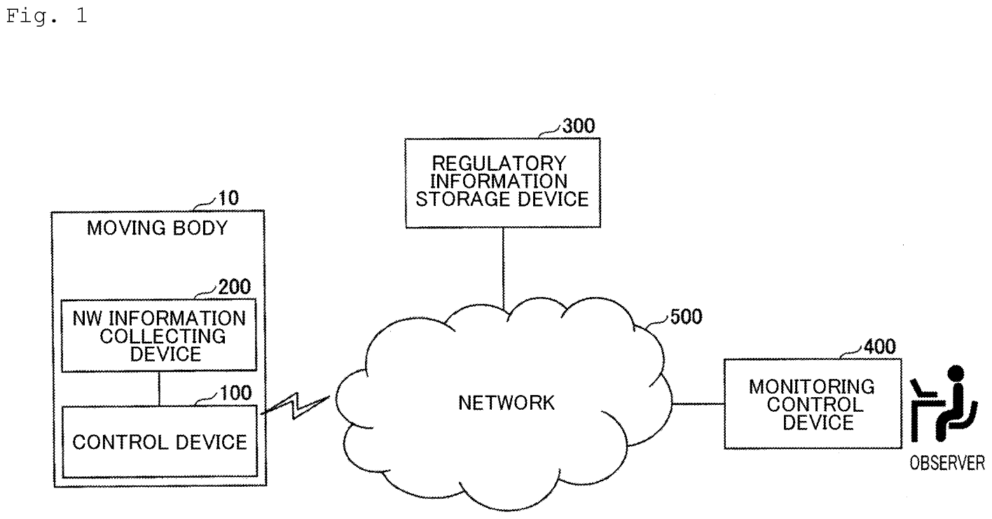

FIG. 1 shows an overall configuration diagram of the system according to the first embodiment (and the second embodiment) of the present invention. As shown in FIG. 1, this system includes a moving body 10, a regulatory information storage device 300, and a monitoring control device 400, and these devices are configured to be able to communicate via a network 500. The network 500 is a network including a mobile network, the Internet, and the like.

In the present embodiment, it is assumed that the moving body 10 is, for example, an agricultural machine such as a tractor having a communication function and an automatic driving function. However, the moving body 10 is not limited to an agricultural machine, and may be a car (automobile) or the like having a communication function and an automatic driving function.

The moving body 10 is provided with a camera, and images (images of around the moving body 10) captured by the camera are sent to the monitoring control device 400, and an observer monitors the images displayed on a display of the monitoring control device 400. In addition to the camera mounted on the moving body 10, cameras may be provided around the moving body 10 and images of the cameras may also be transmitted to the monitoring control device 400.

When the observer watching images detects that the moving body 10 is in a dangerous state from the surrounding conditions of the moving body 10, for example, the observer stops the moving body 10 by operating the monitoring control device 400. Monitoring and control of the moving body may be performed automatically instead of being performed by a person.

As shown in FIG. 1, the moving body 10 includes a control device 100 and an NW information collecting device 200. The control device 100 is a device having functions according to the present invention, and details thereof will be given in later description.

The NW information collecting device 200 collects NW information (which may also be called a NW quality) such as a delay, a packet loss, and jitter related to communication between the monitoring control device 400 and the moving body 10 via the network 500. The control device 100 included in the moving body 10 acquires NW information from the NW information collecting device 200 and executes real-time control on the basis of the NW information. Details of control include, for example, control of the speed of the moving body 10, control of a frame rate of the camera mounted on the moving body 10, and the like.

The regulatory information storage device 300 stores regulatory information such as a stopping distance regulation. The control device 100 acquires the regulatory information from the regulatory information storage device 300 and calculates policy values (which may also be called policy information) on the basis of the regulatory information. The regulatory information storage device 300 may be included on a cloud.

(Overview of Operation of System)

The observer monitors the moving body 10 by viewing images displayed on the display of the monitoring control device 400. When the observer detects that the moving body 10 is dangerous, the observer transmits an instruction to stop the moving body 10 by operating the monitoring control device 400.

A distance from a point where the moving body 10 is in danger (an event determined by the observer to be dangerous) to a point where the moving body 10 actually stops is called a “stopping distance”. The stopping distance according to surrounding conditions and the like is specified in advance, and values thereof are stored in the regulatory information storage device 300. This specified stopping distance means that the moving body 10 must stop in a distance within the stopping distance.

The actual stopping distance of the moving body 10 can be calculated (estimated) by “free running distance+braking distance”. The free running distance is calculated by “(round-trip delay+reaction time interval)×speed of moving body 10” and the braking distance is calculated on the basis of a friction coefficient and the speed of the moving body 10.

The “round-trip delay” is a time interval from when the moving body 10 actually becomes dangerous to when an image thereof is displayed on the monitoring control device 400 (one-way delay) and a time interval from when the observer performs a control operation to when control for stopping is actually executed on the moving body 10 (one-way delay), and in the present embodiment, this “round-trip delay” is regarded as a round-trip delay between the moving body 10 and the monitoring control device 400 in the network 500.

The “reaction time interval” is a time interval from when the observer detects a danger of the moving body 10 through an image to when the observer performs a control operation, and in the present embodiment, is a value set in advance according to the age of the observer, or the like.

For example, in a situation where an NW delay is significant, a road surface is slippery, or the like, even if the observer quickly performs a control operation for stopping upon detection of a danger, it may not be possible to stop the moving body 10 within a specified stopping distance.

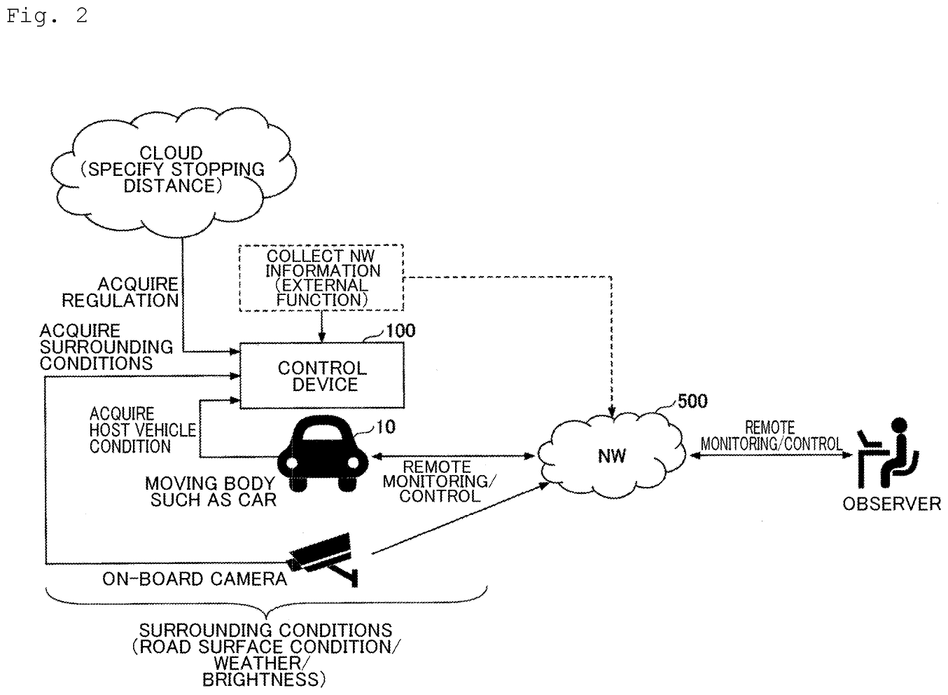

Therefore, in the present embodiment, the control device 100 collects conditions of a host vehicle and surrounding conditions, as shown in FIG. 2, and on the basis of this information, calculates a speed of the moving body 10 at which the moving body 10 can be stopped within the specified stopping distance as a policy value for each NW quality, stores the policy value in a policy DB, and controls the speed of the moving body 10 according to an actual NW quality with reference to the policy DB. Further, the control device 100 also controls a frame rate of the camera according to the NW quality.

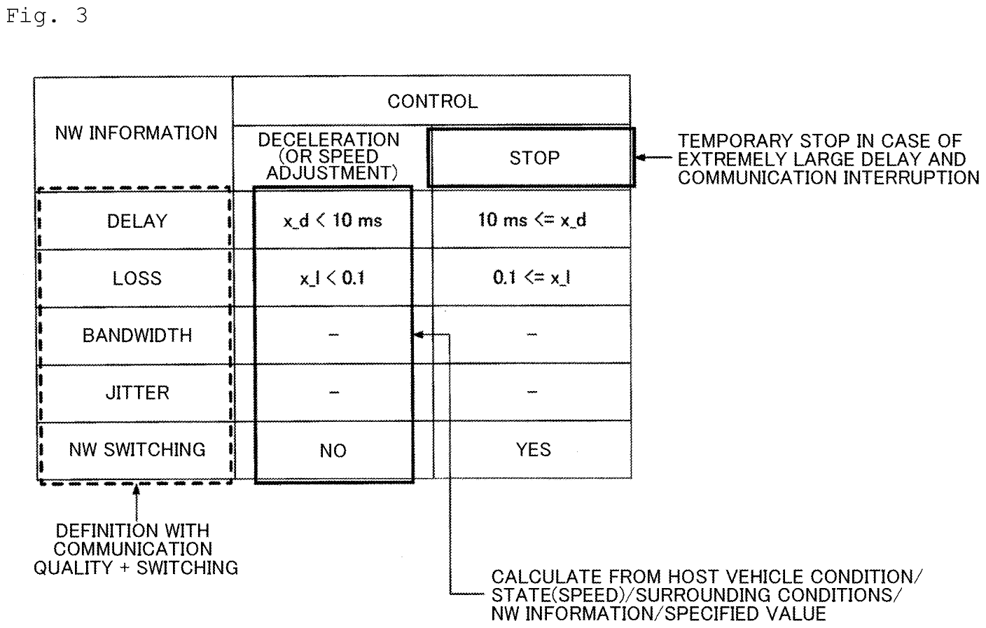

An example of an overview of the policy DB is shown in FIG. 3. In FIG. 3, x_d is an NW delay acquired by the NW information collecting device 200, and x_l is a packet loss acquired by the NW information collecting device 200. In the case of the example shown in FIG. 3, for example, the control device 100 performs control to decelerate the moving body 10 if the NW delay is up to 10 ms and performs control to stop the moving body 10 when the NW delay becomes 10 ms or more.

NW switching shown in FIG. 3 is, for example, a situation in which the communication quality of a 5G network deteriorates when the moving body 10 is connected to the 5G network for communication and thus the moving body 10 switches to an LTE network. When NW switching occurs, communication may be temporarily interrupted. Therefore, in the example of FIG. 3, when NW switching occurs, control for stopping the moving body 10 is executed.

### Configuration Example of Device

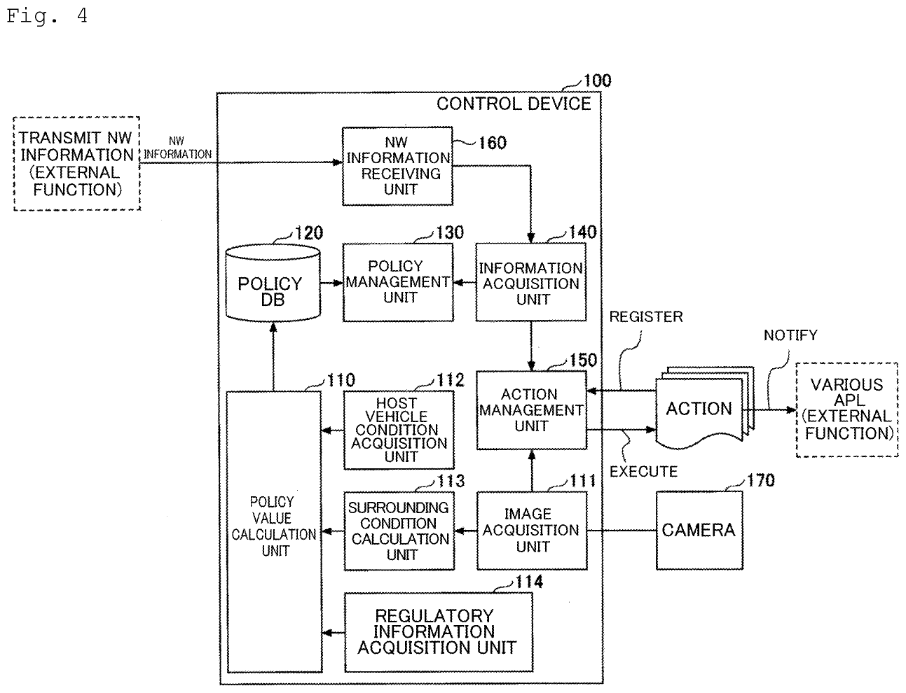

FIG. 4 shows an example of a functional configuration of the control device 100 according to the first embodiment. As shown in FIG. 4, the control device 100 includes a policy value calculation unit 110, an image acquisition unit 111, a host vehicle condition acquisition unit 112, a surrounding condition calculation unit 113, a stopping distance regulation acquisition unit 114, a policy DB 120, a policy management unit 130, an information acquisition unit 140, an action management unit 150, and an NW information receiving unit 160. Further, FIG. 4 also shows a camera 170 connected to the control device 100. The operation of each functional unit, and the like will be described later.

The policy value calculation unit 110 and the surrounding condition calculation unit 113 may be collectively referred to as a policy information calculation unit. Further, the action management unit 150 may also be called a control execution unit.

In addition, the entire control device 100 may be included in the moving body 10, or a part of thereof may be provided outside the moving body 10 (for example, on a cloud). For example, the policy value calculation unit 110 and the policy DB 120 may be provided on a cloud.

### Example of Hardware Configuration

The control device 100 in the present embodiment can be realized by, for example, causing a computer to execute a program describing details of processing described in the present embodiment.

The aforementioned program can be recorded on a computer-readable recording medium (portable memory, or the like), saved, and distributed. Further, the aforementioned program can also be provided through a network such as the Internet or e-mail.

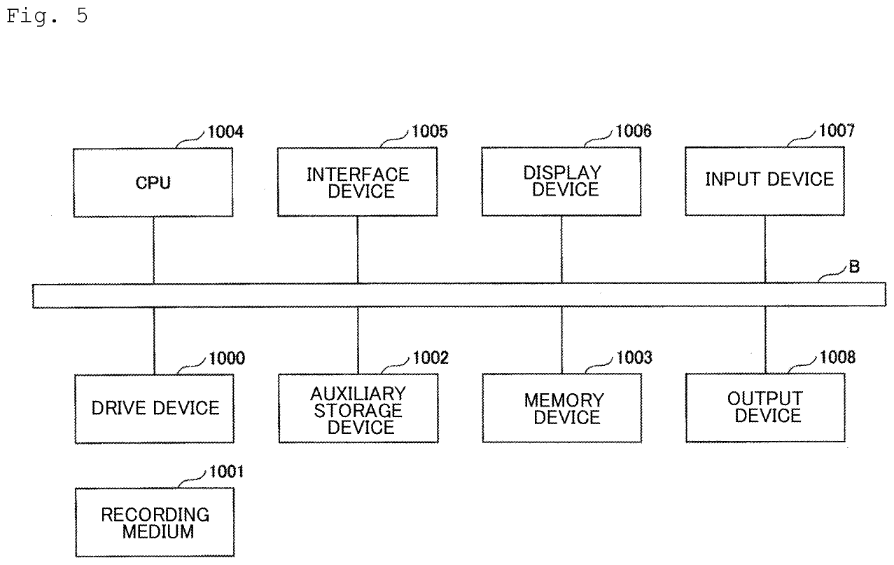

FIG. 5 is a diagram showing an example of a hardware configuration of the aforementioned computer. The computer of FIG. 5 includes a drive device 1000, an auxiliary storage device 1002, a memory device 1003, a CPU 1004, an interface device 1005, a display device 1006, an input device 1007, an output device 1008, and the like, which are connected to each other through a bus BS.

A program that realizes processing in the computer is provided by, for example, a recording medium 1001 such as a CD-ROM or a memory card. When the recording medium 1001 storing the program is set in the drive device 1000, the program is installed in the auxiliary storage device 1002 from the recording medium 1001 via the drive device 1000. However, the program does not necessarily have to be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when the program is instructed to start. The CPU 1004 realizes a function related to the control device 100 according to the program stored in the memory device 1003. The interface device 1005 is used as an interface for connecting to a network. The display device 1006 displays a graphical user interface (GUI) and the like according to the program. The input device 1007 includes a keyboard, a mouse, buttons, a touch panel, and the like and is used to input various operation instructions. The output device 1008 outputs arithmetic operation results.

### Operation Example of Control Device 100

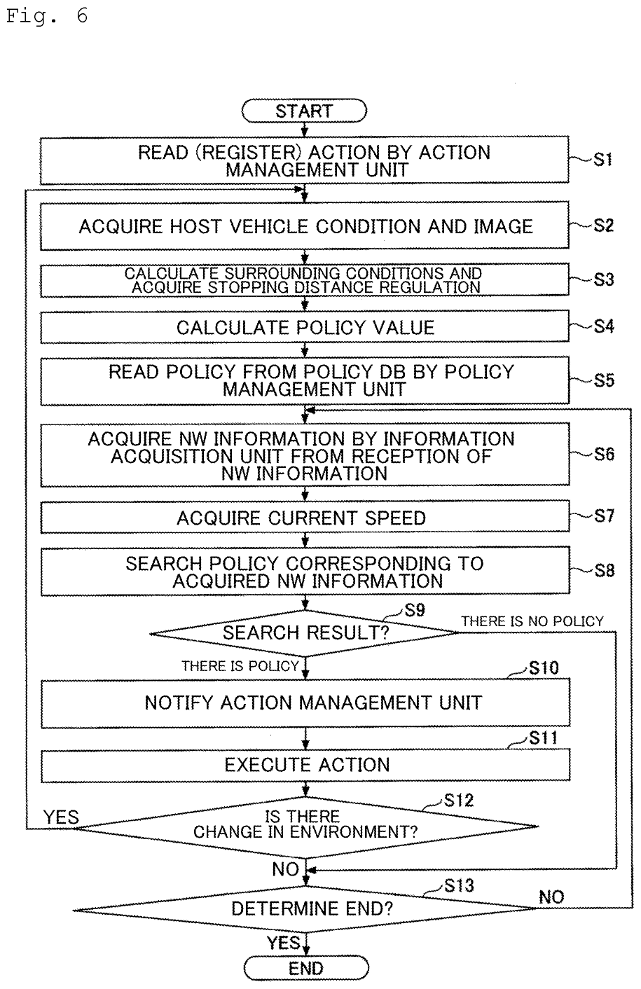

Next, an operation example of the control device 100 according to the first embodiment will be described according to a procedure of the flowchart shown in FIG. 6.

<S1 (Step 1)>

In S1, the action management unit 150 registers (holds) actions that are details of control for the moving body 10. In the present embodiment, the following eight actions are registered.

(1) Control (60 km/h)

(2) Control (30 km/h)

(3) Control (10 km/h)

(4) Control (stop)

(5) Camera (30 FPS)

(6) Camera (10 FPS)

(7) Camera (1 FPS)

(8) Camera (stop)

For example, “Control (30 km/h)” in (2) means control to set the speed of the moving body 10 to 30 km/h. Further, for example, “Camera (30 FPS)” in (5) means control to set a frame rate of the camera 170 to 30 FPS.

<S2>

In S2, the host vehicle condition acquisition unit 112 acquires the type (a car, a tractor, or the like) of the moving body 10 on which the control device 100 is mounted. Regarding a method of acquiring the type, the host vehicle condition acquisition unit 112 may estimate the type from the type of an action or may read information directly provided by the moving body 10. The host vehicle condition acquisition unit 112 may not be provided and host vehicle conditions may be set in advance.

Further, a reaction time interval used in policy value calculation is acquired by, for example, the host vehicle condition acquisition unit 112 (or the surrounding condition calculation unit 113) by receiving information on an observer from the monitoring control device 400. The information on the observer may be the reaction time interval itself, the age of the observer, or the like. When the age of the observer is received, for example, the host vehicle condition acquisition unit 112 estimates a reaction time interval corresponding to the age. Further, a reaction time interval may be set in advance without being acquired/estimated or the like.

In addition, the image acquisition unit 111 acquires an image captured by the camera 170 and transfers the image to the surrounding condition calculation unit 113.

<S3>

In S3, the surrounding condition calculation unit 113 determines road surface conditions, the weather, and a brightness on the basis of the image transferred from the image acquisition unit 111. A determination method is not limited to a specific method, but for both the road surface conditions (concrete or gravel road/wet or not wet) and the weather (sunny or rain/snow), for example, each state is learned as correct data and the state of the image is determined on the basis of learning data. Regarding the brightness, daytime or nighttime is determined from the brightness of the image.

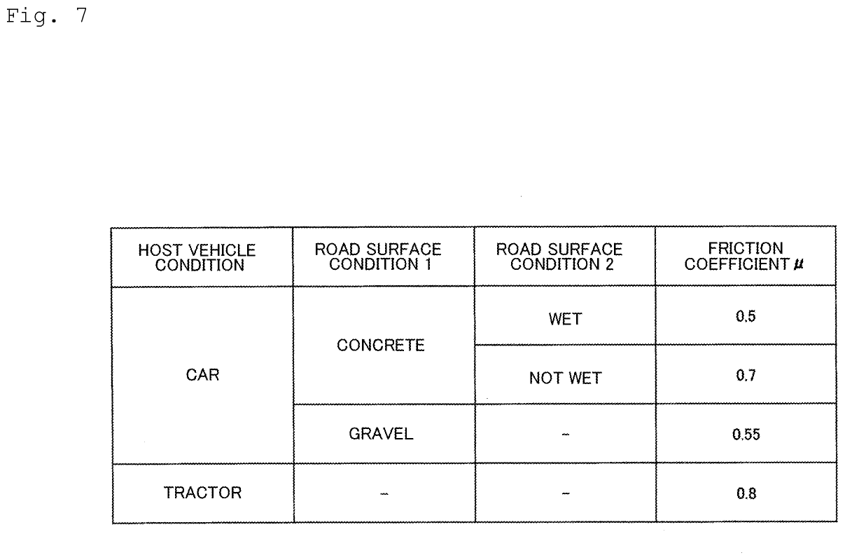

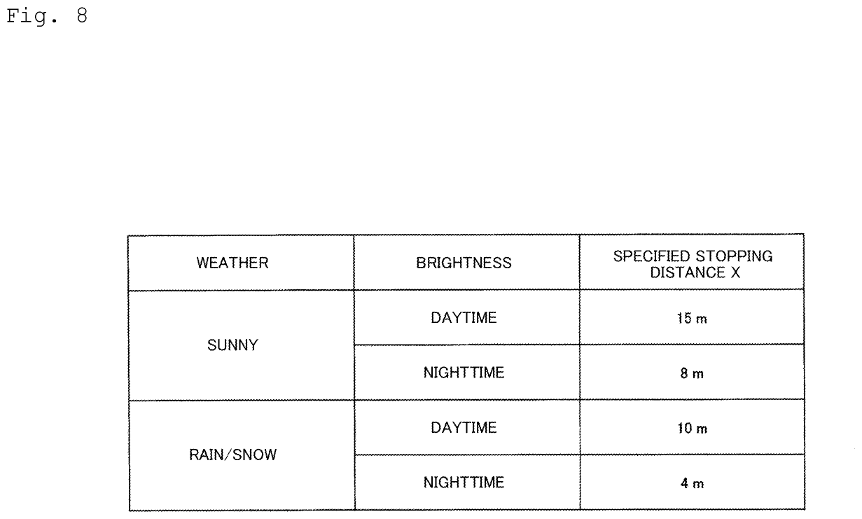

The regulatory information acquisition unit 114 acquires regulatory information according to a host vehicle condition and surrounding conditions from the regulatory information storage device 300. Examples of regulatory information to be acquired are shown in FIG. 7 and FIG. 8. FIG. 7 shows an example in which a friction coefficient is acquired as regulatory information. For example, when a host vehicle condition is “vehicle” and road surface conditions are “concrete” and “wet”, 0.5 is acquired as a friction coefficient from the regulatory information storage device 300.

FIG. 8 shows an example of a case of acquiring a specified stopping distance as regulatory information. For example, when the weather is “sunny” and the brightness is “daytime”, 15 m is acquired as a specified stopping distance from the regulatory information storage device 300.

<S4>

The policy value calculation unit 110 calculates policy values according to a network state on the basis of a host vehicle condition acquired by the host vehicle condition acquisition unit 112, a surrounding condition calculated by the surrounding condition calculation unit 113, and regulatory information acquired by the regulatory information acquisition unit 114 and writes the calculated policy values in the policy DB 120. The NW state is an NW quality (a delay, a packet loss, a bandwidth, jitter, etc.), NW switching, or both the NW quality and NW switching. In addition, an NW quality and NW switching may be collectively referred to as a NW quality.

(Example 1) and (Example 2) of a method of calculating policy values by the policy value calculation unit 110 will be described below.

### (Example 1) Calculation of Policy Values of Moving Body Control According to NW Delay

As Example 1, a method of calculating policy values (policy information) for controlling the speed of the moving body 10 according to a NW delay will be described. Here, the “NW delay” is a round-trip delay time interval of the NW between the moving body 10 and the monitoring control device 400.

Here, policy values for causing a stopping distance from a point where a danger of the moving body 10 detected by the observer occurs to a point where the moving body 10 stops to be a specified stopping distance or less are calculated on the basis of Formula 5 obtained from Formula 1 to Formula 4 below. The stopping distance d may be referred to as a braking stopping distance.

Free running distance d_{f} [m]=(reaction time interval tᵣ [s]+round-trip delay time interval t [s])×speed of moving body v [km/h]×(1000/3600) Formula 1

Braking distance d_{b} [m]=v²/(254×friction coefficient μ) Formula 2

Stopping distance d [m]=free running distance d_{f} [m]+braking distance d_{b} [m] Formula 3

Stopping distance d [m]×(specified stopping distance) Formula 4

t≤3.6((X/v)−(v/(254×μ)))−tᵣ Formula 5

In the present embodiment, as an example, it is assumed that μ=0.7 because current surrounding conditions are “car/road surface (concrete/not wet)”, X=15 m because surrounding conditions are “sunny/daytime”, and the reaction time interval is tᵣ=1 s.

In this case, the right side of Formula 5 is 0.2 s if v=30 [km/h] and 4.2 s if v=10 [km/h], for example.

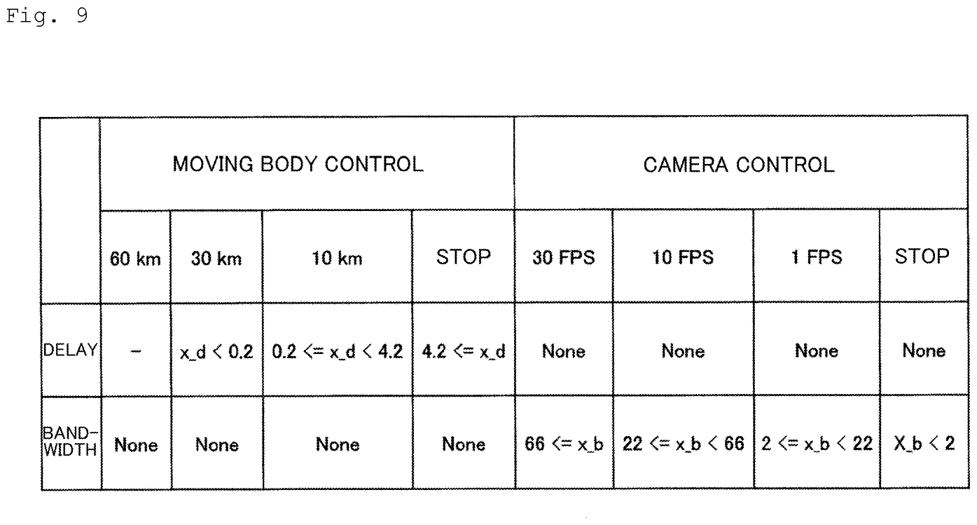

That is, when the speed of the moving body 10 is 30 [km/h], the stopping distance is equal to or less than the specified stopping distance if the NW delay is less than 0.2 s. Further, when the speed of the moving body 10 is 10 [km/h], the stopping distance is equal to or less than the specified stopping distance if the NW delay is less than 4.2 s. On the basis of such calculation, policy values shown in the row “delay” of the column “moving body control” of FIG. 9 can be calculated as policy values relating to control of the moving body 10 according to NW delay. In the policy values, x_d is an NW delay [s] acquired from the NW information collecting device 200.

The policy values shown in the row “delay” of the column “moving body control” of FIG. 9 mean that the stopping distance cannot be equal to or less than the specified stopping distance no matter how small the NW delay is when the speed of the moving body 10 is higher than 30 km.

That is, if the NW delay x_d is less than 0.2 s and the speed of the moving body 10 exceeds 30 km, the speed of the moving body 10 is controlled such that it is 30 km. Further, if the NW delay x_d is 0.2 s or more and less than 4.2 s and the speed of the moving body 10 is higher than 10 km, the speed of the moving body 10 is controlled such that it is 10 km. Further, if the NW delay x_d is 4.2 s or more, the moving body 10 is controlled such that it stops. The policy values shown in the row “delay” of the column “moving body control” of FIG. 9 are exemplary. For example, policy values may be set such that finer speed control is performed.

### (Example 2) Calculation of Policy Values of Camera Control According to NW Bandwidth

As Example 2, a method of calculating policy values for controlling a frame rate of the camera 170 according to an NW bandwidth will be described. Here, the “NW bandwidth” is an NW bandwidth between the moving body 10 and the monitoring control device 400. The “NW bandwidth” may be an NW bandwidth between the camera 170 and the monitoring control device 400.

Here, a policy value (required NW bandwidth) for causing an image monitored by the observer to look normal (that is, for causing a danger to be able to be detected without stopping) is calculated on the basis of Formula 6 below.

Required bandwidth [bps]=resolution x number of bits per frame x FPS x compression rate [%] Formula 6 The policy value calculation unit 110 can acquire the resolution of the camera 170, the number of bits per frame, and the compression rate from, for example, the image acquisition unit 111.

In the present embodiment, as an example, it is assumed that the resolution is 1280×720, the number of bits per frame is 24, and the compression rate is 10%.

In this case, the right side of Formula 6 is 66355200 bps (about 66 [Mbps]) if FPS=30, 22118400 bps (about 22 [Mbps]) if FPS=10, and 2211840 bps (about 2 [Mbps]) if FPS=1, for example. On the basis of such calculation, policy values shown in the row “bandwidth” of the column “camera control” of FIG. 9 can be calculated as policy values relating to control of the camera 170 according to an NW bandwidth. In the policy values, x_b indicates an NW bandwidth [Mbps] acquired by the NW information collecting device 200. These policy values mean that the following control is performed.

That is, when the NW bandwidth x_b is 66 Mbps or more, the FPS of the camera 170 is controlled such that it is 30 if the FPS of the camera 170 exceeds 30. Further, when the NW bandwidth x_b is less than 66 Mbps and 22 Mbps or more, the FPS of the camera 170 is controlled such that it is 10 if the FPS of the camera 170 exceeds 10. Further, when the NW bandwidth x_b is less than 22 Mbps and 2 Mbps or more, the FPS of the camera 170 is controlled such that it is 1 if the FPS of the camera 170 exceeds 1. When the NW delay x_b is less than 2 Mbps, the camera 170 is controlled such that it stops. The policy values shown in the row “bandwidth” of the column “camera control” of FIG. 9 are exemplary. For example, policy values may be set such that finer FPS control is performed.

<S5>

In S5, the policy management unit 130 acquires policy information (e.g., information shown in FIG. 9) from the policy DB 120.

<S6>

The NW information receiving unit 160 receives NW information from the NW information collecting device 200. In S6, the information acquisition unit 140 acquires NW information (a delay and a bandwidth in the present embodiment) from the NW information receiving unit 160.

<S7>

In S7, the information acquisition unit 140 acquires the current traveling speed of the moving body 10. The information acquisition unit 140 may acquire the speed of the moving body 10 from a speedometer or the like of the moving body 10 or acquire the speed from change over time in the position of the moving body 10 by including a positioning function such as a GPS receiver.

<S8 and S9>

The information acquisition unit 140 determines whether or not there is a policy value corresponding to the NW information by searching policy information read from the policy DB 120 by the policy management unit 130 on the basis of the NW information acquired in S6.

If it is determined that “there is a policy value” in S9, processing proceeds to S10, and if it is determined that “there is no policy value” in S9, processing proceeds to S13.

<S10>

In S10, the information acquisition unit 140 notifies the action management unit 150 of the policy value corresponding to the NW information.

<S11>

In S11, the action management unit 150 executes an action based on the policy value notified from the information acquisition unit 140 in S10.

<S12>

The action management unit 150 checks whether or not there is a change in the surrounding conditions (environment) on the basis of the image acquired from the image acquisition unit 111. Here, cases of changes in which surrounding conditions are determined to have changed, such as a change from a concrete road to a gravel road, a change from a wet state to a non-wet state, and the like, for example, are defined in advance, and the action management unit 150 checks whether or not there is a change in the surrounding conditions (environment) on the basis of such definition.

If it is determined that there is a change in the surrounding conditions in S12, processing returns to S2, and if it is determined that there is no change in the surrounding conditions in S12, processing proceeds to S13.

<S13>

In S13, processing ends if the action management unit 150 determines that processing ends, and processing returns to S6 if the action management unit 150 determines that processing is continued. Regarding determination of end, for example, when the observer instructs the control device 100 to end the operation on the moving body 10 (e.g., an agricultural machine), processing is determined to end.

### Example in First Embodiment

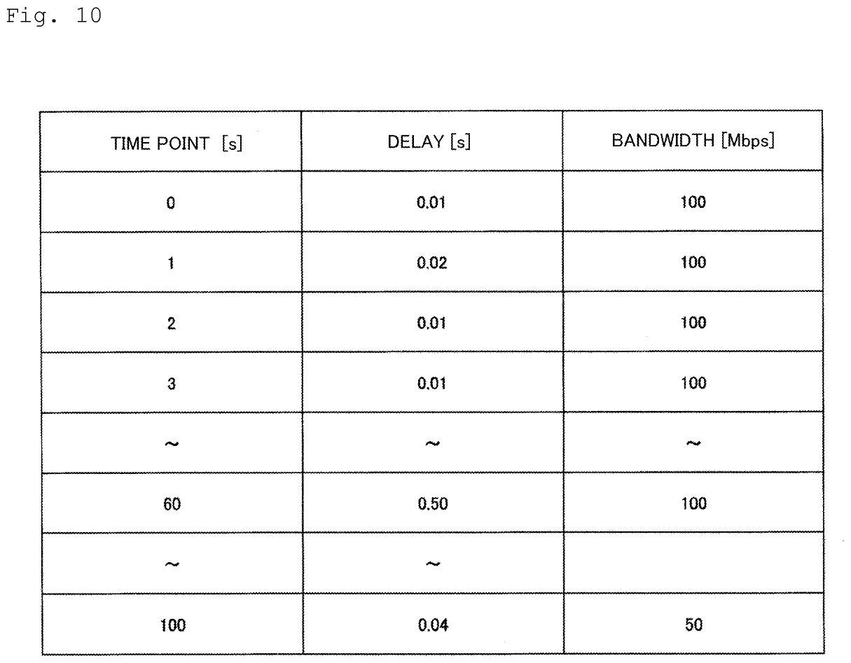

A more specific operation example will be described according to the flow of FIG. 6. As an example, it is assumed that NW information (delay and bandwidth) shown in FIG. 10 is acquired every time point (here, every 1 s) in S6 of FIG. 6.

As shown in FIG. 10, a delay acquired in S6 is 0.01 s and a bandwidth is 100 Mbps at the first point in time (time point=0 s). It is assumed that the speed of the moving body 10 is 0 km/h at time=0 s in S7.

In determination of S9, the delay at the present point in time (time point=0 s) is 0.01 s, and thus moving body control=30 km/h is searched as a corresponding policy value when the policy information of FIG. 9 is searched. In addition, since the bandwidth is 100 Mbps, the policy value of the camera control is searched as 30. In this case, processing proceeds to S10.

In S10, the action management unit 150 is notified of “moving body control=30 km/h” and “camera control=30 FPS” at the present point in time (time point=0 s).

In S11, since the policy value is “moving body control=30 km/h”, the action management unit 150 executes pre-registered action=control (30 km/h). This control instruction is notified to the moving body 10 as a command for the moving body 10 by, for example, an external application, and the moving body 10 starts to travel at 30 km/h. Similarly, the camera 170 performs image capturing at 30 FPS.

It is assumed that there is no change in the surrounding conditions at the present point in time (time point=0 s) in S12 and determination of end is NO similarly in S13. Thereafter, a delay and a bandwidth shown in FIG. 10 are acquired every second and traveling at 30 km/h and image capturing at 30 FPS are continued on the basis of policy information in the same manner as described above until a time point 59.

At a point in time of time point=60 s, delay=0.50 s is acquired in S6 and speed=30 km/h is acquired in S7. At this time, the corresponding policy is controlled (speed=10 km/h) in S8 and S9, as shown in FIG. 9.

Therefore, the action management unit 150 executes the corresponding action in S11, and thus the speed of the moving body 10 is reduced to 10 km/h. As a result, even if there is a delay of both an image to the observer and a control signal from the observer due to an increase in the NW delay, the moving body 10 can be stopped within the specified stopping distance.

Thereafter, similarly, the state of speed=10 km/h is maintained because the state of large delay continues until time point=99 s.

Since the delay has become 0.04 s at a point in time of time point=100 s, the speed becomes 30 km/h as a result of referring to the policy information. Further, at this time, the bandwidth has become 50 Mbps, and thus the action management unit 150 resets the FPS of the camera 170 from 30 to 10 by executing the corresponding control.

### Second Embodiment

Next, a second embodiment will be described. A system configuration and operation in the second embodiment are basically the same as the system configuration and operation in the first embodiment, but there are some differences. Hereinafter, differences from the first embodiment will be mainly described.

As in the first embodiment, the moving body 10 can be stopped within a specified stopping distance from a remote location in accordance with a host vehicle condition and surrounding conditions in the second embodiment. If the moving body 10 cannot be stopped within a specified stopping distance according to an NW state, control is performed to stop the moving body 10 in advance.

In the second embodiment, the NW information collecting function can acquire a current NW quality (measured value) and can also estimate a future NW quality (predicted value).

Further, in the second embodiment, when the stopping distance of the moving body 10 cannot be guaranteed due to a NW state (for example, when a communication interruption occurs or a delay is extremely large), the speed of the moving body 10 can be reduced to an appropriate speed in addition to stopping of the moving body 10. At a point in time when the NW state is restored, a normal operation is resumed. Further, as in the first embodiment, a NW delay (an allowable round-trip delay time interval t) that guarantees the stopping distance of the moving body 10 is dynamically calculated as a policy value in the second embodiment.

In the first embodiment, t was calculated by the following formula (Formula 5 described above).

t≤3.6((X/v)−(v/(254×μ)))−tᵣ

However, whether this value is a predicted value or a measured value is not limited in the first embodiment. On the other hand, this part is extended to calculate a threshold value of the NW quality (measured value/predicted value) and a speed after deceleration after exceeding the threshold value in the second embodiment.

In calculation of the threshold value of the NW quality (measured value/predicted value), it is possible to add jitter and perform the calculation on the basis of a round-trip NW transmission time interval. The round-trip NW transmission time interval may also be referred to as a round-trip NW delay, a NW delay, or the like.

Specific formulas are as follows. Formula 8 and Formula 9 are obtained from Formula 7. Formula 9 is a formula in which t has been added.

d=(v/3.6)t_{TAT}+v²/254μ≤X Formula 7

t≤3.6((X/v)−(v/(254×μ)))−t_{c} Formula 8

t≤3.6((X/v)−(v/(254×μ)))−t_{c}−tⱼ Formula 9

The meanings of the variables used in the above formulas are as follows.

d: braking stopping distance [m]

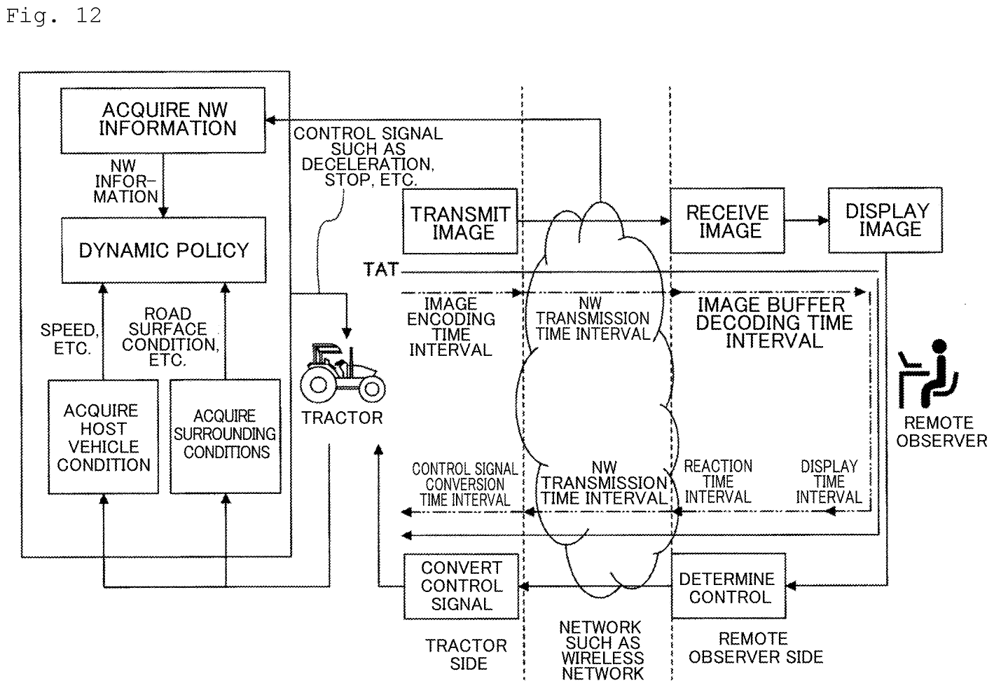

t_{TAT}=t+t_{c}: turn around time (TAT) [s] (TAT will be described later in FIG. 12)
t: round-trip NW transmission time interval [s]
t_{c}: time interval treated as a constant, such as a reaction time interval and an image encoding time interval [s]
t: jitter (delay fluctuation) [s]
v: device speed [km/h]
X: specified stopping distance [m]
μ: friction coefficient

Formula 8 is called a predicted value/measured value secondary expression, and Formula 9 is called a measured value primary expression. For Formula 8, a predicted value of a round-trip NW delay can be used in control and a measured value can also be used.

When control is performed with a predicted value (that is, a future value) using Formula 8, deceleration can be completed by starting deceleration at a point in time when the predicted value exceeds an allowable delay time interval. On the other hand, when control is performed with a measured value, stop by sudden braking is performed at a point in time when the measured value exceeds the allowable delay time interval. The same applies to a case where the formulas in the first embodiment are used.

By using Formula 9, control is performed with a measured value without performing sudden braking because the allowable delay time interval is calculated by adding jitter. That is, deceleration can be completed by starting deceleration at a point in time when a measured value exceeds the allowable delay time interval by using Formula 9.

In the second embodiment, a speed after deceleration is set based on the NW quality (here, NW delay). The speed after deceleration can be calculated as v (0) that satisfies the following Formula 10 by replacing the inequality sign in Formula 7 with an equal sign and setting t_{TAT}=t+t_{c}+tⱼ.

V²/254μ+(v/3.6)(t+t_{c}+t)−X=0 Formula 10

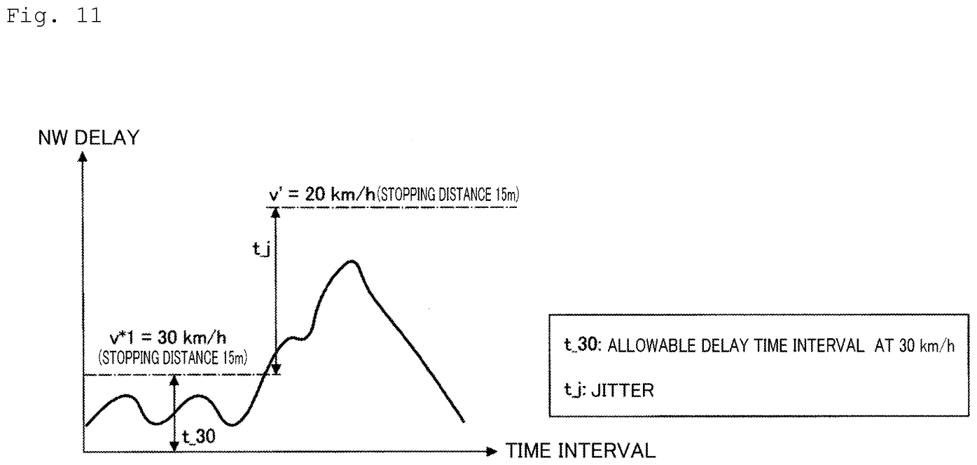

A specific example of speed setting after deceleration will be described with reference to FIG. 11. As shown in FIG. 11, when an NW delay value (a measured value) exceeds an allowable delay time interval (t_30) at 30 km/h (stopping distance of 15 m), the speed is reset on the basis of Formula 10. The example of FIG. 11 shows a case where the speed after deceleration is calculated as 20 km/h by adding jitter tⱼ.

Regarding jitter, a statistical value based on past data may be used, or it may be calculated in advance according to an estimated value by machine learning or the like.

Subsequently, TAT will be described with reference to FIG. 12. FIG. 12 shows a case where the moving body 10 is a tractor, for example. As shown in FIG. 12, TAT is a time interval from when a remote observer visually confirms and determines an image of a camera mounted on the moving body 10 until a control signal from the remote observer reaches the moving body 10. That is, in the case of FIG. 12, TAT=“image encoding time interval”+“NW transmission time interval for remote observer”+“image buffer decoding time interval”+“display time interval”+“reaction time interval”+“NW transmission time interval for moving body”+“control signal conversion time interval”.

According to the above-described technology, it is possible to realize control (acceleration/deceleration) that guarantees a stopping distance according to the operating environment (host vehicle condition+surrounding conditions) of the moving body 10 in consideration of a measured value or a predicted value (or both the measured value and the predicted value) of the NW quality.

Hereinafter, an example of a device configuration and an example of operation (example) in the second embodiment will be described.

### Example of Device Configuration

The overall configuration of the system in the second embodiment is the same as that in the first embodiment, as shown in FIG. 1 and FIG. 2.

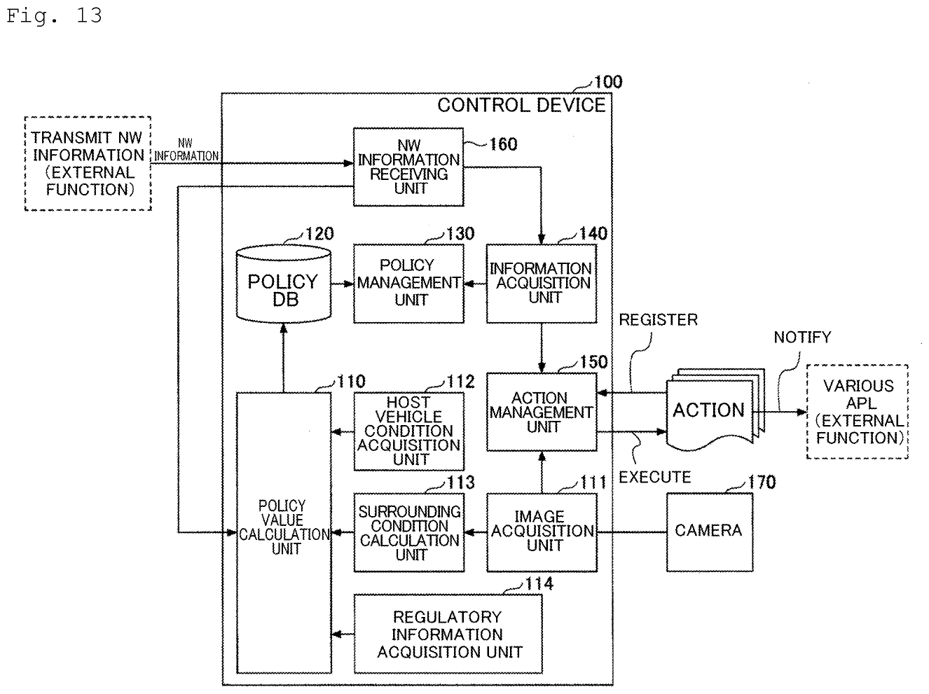

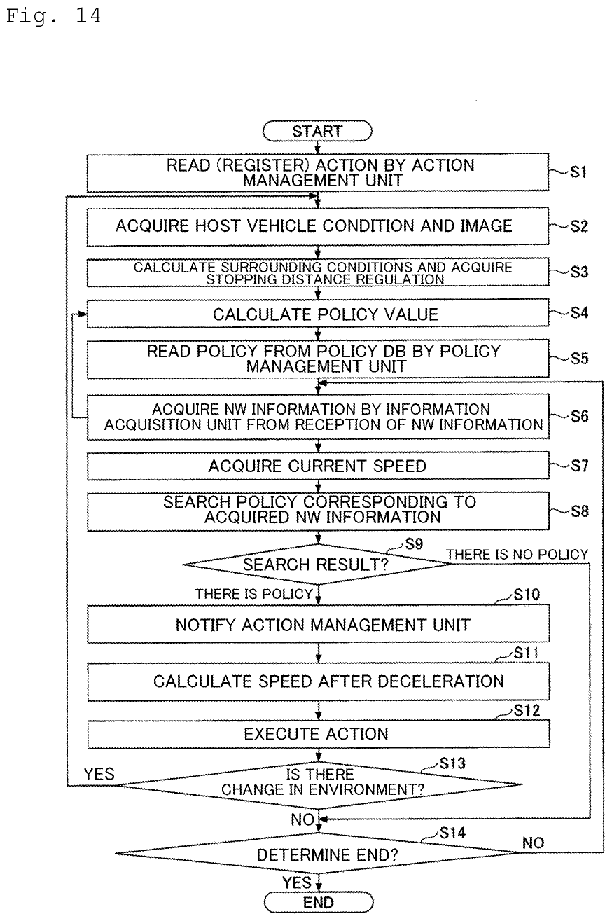

FIG. 13 shows an example of a functional configuration of the control device 100 according to the second embodiment. As shown in FIG. 14, the control device 100 includes the policy value calculation unit 110, the image acquisition unit 111, the host vehicle condition acquisition unit 112, the surrounding condition calculation unit 113, the stopping distance regulation acquisition unit 114, the policy DB 120, the policy management unit 130, the information acquisition unit 140, the action management unit 150, and the NW information receiving unit 160. Further, FIG. 13 also shows the camera 170 connected to the control device 100.

As shown in FIG. 13, the functional configuration of the control device 100 in the second embodiment is the same as the functional configuration of the control device 100 in the first embodiment. The operation of each functional unit is basically the same as that of the first embodiment. However, in the second embodiment, the policy value calculation unit 110 calculates policy values using Formula 8 and Formula 9 and the action management unit 150 (control execution unit) calculates a speed after deceleration using Formula 10. In addition, the hardware configuration is the same as that of the first embodiment and is as described with reference to FIG. 5.

The policy value calculation unit 110 and the surrounding condition calculation unit 113 may be collectively referred to as a policy information calculation unit. Further, the action management unit 150 may be referred to as a control execution unit.

Further, the entire control device 100 may be included in the moving body 10, or a part thereof may be provided outside the moving body 10 (for example, on a cloud). For example, the policy value calculation unit 110 and the policy DB 120 may be provided on the cloud.

### Example in the Second Embodiment

FIG. 14 is a flowchart showing the operation of the control device 100 in the second embodiment. It is basically the same as the flow in the first embodiment shown in FIG. 6. However, in the second embodiment, policy values are calculated using NW information. Further, the speed after deceleration is calculated in S11 in FIG. 14. Hereinafter, an example based on the flow of FIG. 14 will be described.

<S1 (Step 1)>

In S1, the action management unit 150 registers (holds) actions that are details of control with respect to the moving body 10. In the present embodiment, the following three actions are registered.

(1) Control (30 km/h: initial speed)

(2) Control (Y km/h)

(3) Control (0 km/h: stop) Y mentioned above is dynamically calculated by the above-described “speed calculation after deceleration”. The stop operation is performed when Y1. For example, “Control (Y km/h)” of (2) means a control to set the speed of the moving body 10 to Y km/h.

<S2>

In S2, the host vehicle condition acquisition unit 112 acquires the type (a car, a tractor, or the like) of the moving body 10 on which the control device 100 is mounted. Further, the image acquisition unit 111 acquires an image captured by the camera 170 and transfers the image to the surrounding condition calculation unit 113.

<S3>

In S3, the surrounding condition calculation unit 113 determines road surface conditions, the weather, and a brightness on the basis of the image transferred from the image acquisition unit 111. The regulatory information acquisition unit 114 acquires regulatory information according to the host vehicle condition and the surrounding conditions from the regulatory information storage device 300. Examples of regulatory information to be acquired are as shown in FIG. 7 and FIG. 8.

<S4>

The policy value calculation unit 110 calculates policy values according to an NW state on the basis of the host vehicle condition acquired by the host vehicle condition acquisition unit 112, the surrounding conditions calculated by the surrounding condition calculation unit 113, the regulatory information acquired by the regulatory information acquisition unit 114, NW information acquired by the NW information receiving unit 160, and a current traveling speed of the moving body 10 acquired by the information acquisition unit 140 (or a speed indicated to the moving body by the action management unit 150) and writes the calculated policy values in the policy DB 120. The NW state is a NW quality (a delay, a packet loss, a bandwidth, jitter, and the like), NW switching, or both the NW quality and NW switching. In addition, the NW quality and NW switching may be collectively referred to as a NW quality.

Here, as an example, a delay policy value when car/road surface (concrete/not wet): μ=0.7, sunny/daytime: X=15 m, t_{c}=1.0 s, and jitter tⱼ=0.15 s is calculated by the aforementioned Formula 8 (prediction/measurement secondary expression) and Formula 9 (measurement primary expression). Specifically, t (allowable round-trip NW delay) is calculated using a formula in which the inequality signs in Formula 8 and Formula 9 are replaced with equal signs.

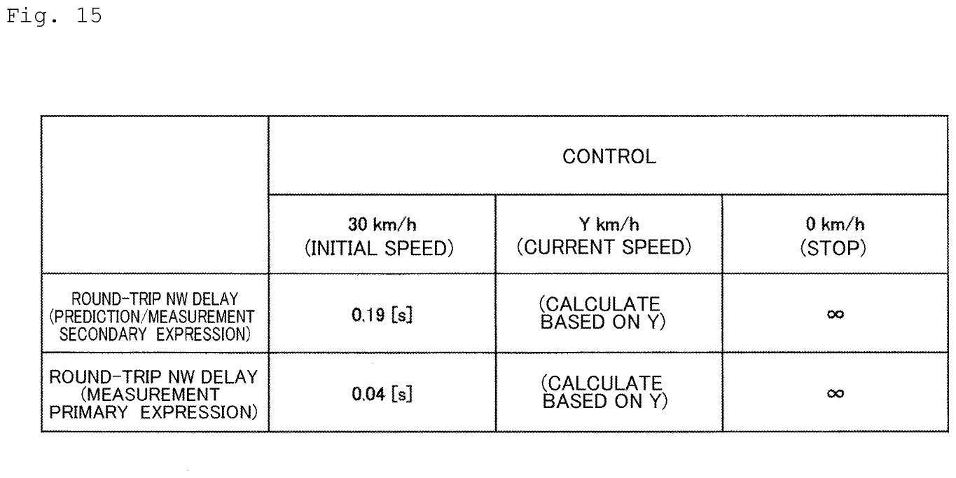

The policy value calculation unit 110 writes the calculated values in the policy DB 110. FIG. 15 shows an example of policy values written in the policy DB 110. For example, in the case of using a value obtained by the measurement primary expression in control, when the speed of the moving body 10 is 30 [km/h], the stopping distance is equal to or less than a specified stopping distance if an NW delay that is a measured value is less than 0.04 s. Deceleration control is performed if the NW delay is 0.04 s or more (or greater than 0.04 s). If a speed after deceleration is Y, the same control (additional deceleration, speed increase, or the like) is performed on the basis of a policy value (NW delay) calculated on the basis of Y.

<S5>

In S5, the policy management unit 130 acquires policy information (e.g., information shown in FIG. 15) from the policy DB 120.

<S6>

The NW information receiving unit 160 receives NW information from the NW information collecting device 200. In S6, the information acquisition unit 140 acquires NW information (round-trip NW delay in the present embodiment) from the NW information receiving unit 160.

In S7, the information acquisition unit 140 acquires a current traveling speed of the moving body 10. The information acquisition unit 140 may acquire the speed of the moving body 10 from the speedometer or the like of the moving body 10, or acquire the speed from change over time in the position of the moving body 10 by including a positioning function such as a GPS receiver.

<S8 and S9>

The information acquisition unit 140 determines whether or not there is a policy value corresponding to the NW information by searching the policy information read from the policy DB 120 by the policy management unit 130 on the basis of the NW information acquired in S6.

If determination in S9 is “there is a policy value”, processing proceeds to S10, and if determination in S9 is “there is no policy value”, processing proceeds to S14.

<S10>

In S10, the information acquisition unit 140 notifies the action management unit 150 of the policy value corresponding to the NW information.

<S11>

In this example, it is assumed that a round-trip NW delay is greater than a policy value of the round-trip NW delay corresponding to the current speed, for example. In this case, the action management unit 150 calculates a speed after deceleration by solving Formula 10 with respect to v. If it is not necessary to calculate the speed after deceleration, S11 is not performed.

<S12>

In S12, the action management unit 150 executes an action. For example, it performs control to decelerate the moving body 10.

<S13>

The action management unit 150 checks whether or not there is a change in the surrounding conditions (environment) on the basis of the image acquired from the image acquisition unit 111. Here, cases of changes in which surrounding conditions are determined to have changed, such as a change from a concrete road to a gravel road, a change from a wet state to a non-wet state, and the like, for example, are defined in advance, and the action management unit 150 checks whether or not there is a change in the surrounding conditions (environment) on the basis of such definition. Further, it is also determined that the environment has changed when the speed of the moving body 10 has changed (for example, when the speed is reduced by a deceleration instruction).

Processing returns to S2 if it is determined that there is a change in the surrounding conditions in S13 and processing proceeds to S14 if it is determined that there is no change in the surrounding conditions in S13.

<S14>

In S14, processing ends if the action management unit 150 determines that processing ends, and processing returns to S6 if it determines that processing is continued. Regarding determination of end here, for example, it is determined that processing ends when the observer instructs the control device 100 to end the operation on the moving body 10 (e.g., an agricultural machine).

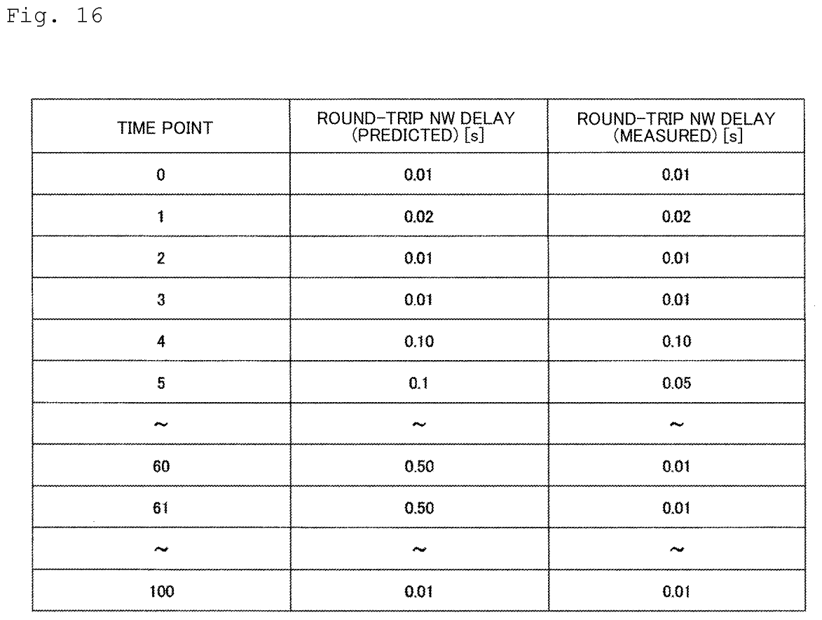

Next, a more specific operation example based on the flow of FIG. 14 will be described. As an example, it is assumed that NW information (a predicted value and a measured value of a round-trip NW delay) shown in FIG. 16 is acquired every time point (here, every 1 s).

As shown in FIG. 16, both a predicted value and a measured value of a round-trip NW delay acquired at the initial point in time (time point=0 s) are 0.01 s. It is assumed that the speed of the moving body 10 is 0 km/h at time point=0 s.

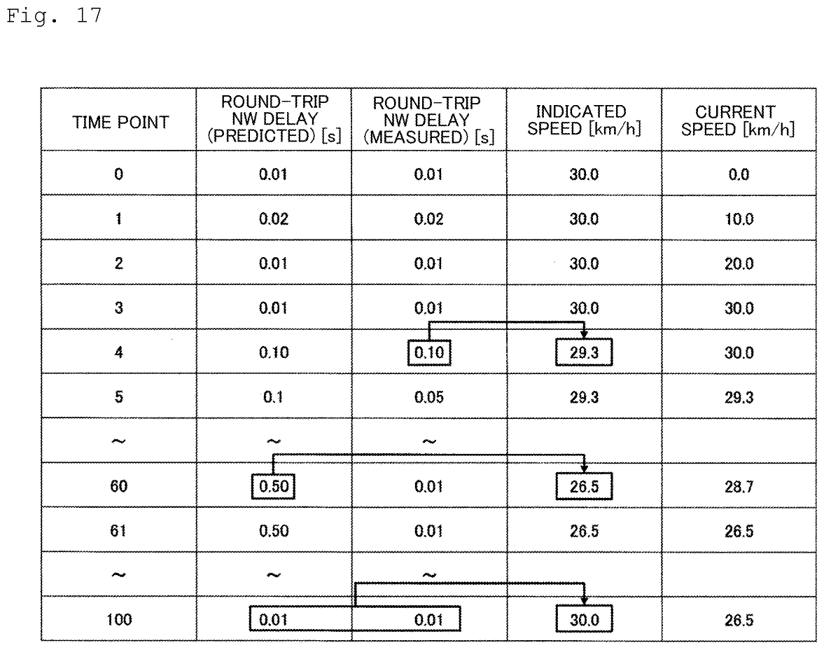

FIG. 17 shows indicated speeds for the moving body 10 based on control and current speeds of the moving body 10 at that time point in addition to the round-trip NW delay. Hereinafter, the operation at each time point will be described with reference to FIG. 17. Further, in FIG. 17, a part of particular interest is surrounded by a thick frame.
Time points 0 to 3
   Since a result of referring to the policy DB 120 (FIG. 15) based on a delay of 0.01 at a point in time of time point 0 corresponds to control (30 km/h: initial speed), the information acquisition unit 140 notifies the action management unit 150 of control (30 km/h). The action management unit 150 executes the corresponding action (instructing 30 km/h). The same applies to time points 1 to 3.
Time points 4 and 5

Since the round-trip NW delay (measurement) exceeds 0.04 at a point in time of time point 4, the action management unit 150 calculates Y=29.3 km/h on the basis of Formula 10 and executes the action of control (Y km/h). In the example of FIG. 17, the current speed=indicated speed at time point 5.
Time points 60 and 61

0.25 is calculated as a threshold value in the round-trip NW delay (prediction) when the speed is 29.3 km/h and is stored in the policy DB 120.

Since the round-trip NW delay (prediction) exceeds 0.25 at a point in time of time point 60, the action management unit 150 calculates Y=26.5 km/h on the basis of Formula 10 and executes the action of control (Y km/h). In the example of FIG. 17, current speed=indicated speed at time point 61.
Time point 100 and thereafter

At a point in time when all of round-trip NW delays (predictions/measurements) fall below the threshold value of control (30 km/h: initial speed), the speed of the moving body 10 is restored to the initial speed.

Although an example in which both a predicted value and a measured value of the round-trip NW delay are used is shown in the above example, calculation of a speed after deceleration using Formula 10 can be performed even when only the measured value of the round-trip NW delay is acquired, and thus the same control can be executed.

### Advantages of Embodiments

As described above, it is possible to appropriately control a moving body according to network quality and surrounding conditions in a system of monitoring the moving body from a remote location via a network through the technology according to the first and second embodiments.

### Summary of Embodiments

This specification describes at least a control device, a control method, and a program described in the following items.

### (First Item)

A control device for controlling a moving body in a system of monitoring the moving body from a remote location via a network, the control device including a policy database configured to store policy information for controlling the moving body, a policy information calculation unit configured to calculate policy information indicating details of control according to a quality of the network on the basis of surrounding conditions of the moving body and to store the policy information in the policy database, and a control execution unit configured to acquire the quality of the network and to execute control corresponding to the quality of the network with reference to the policy information.

### (Second Item)

The control device according to the first item, wherein the policy information is information indicating a speed of the moving body according to the quality of the network, and the control execution unit determines a speed according to the acquired quality of the network on the basis of the policy information and controls the moving body such that the moving body travels at the determined speed.

### (Third Item)

The control device according to the first or second item, wherein the policy information calculation unit calculates, as the policy information, a speed at which the moving body is able to stop within a specified stopping distance for each quality of the network when an observer instructs the moving body to stop from a remote location.

### (Fourth Item)

The control device according to any one of the first to third items, wherein, when a round-trip network delay as the quality of the network exceeds a threshold value, the control execution unit calculates a speed of the moving body after deceleration using a TAT to which a jitter has been added and controls the moving body such that the moving body travels at the calculated speed.

### (Fifth Item)

The control device according to the fourth item, wherein the policy information calculation unit calculates the threshold value using the jitter, the specified stopping distance, the speed of the moving body, a friction coefficient, and a predetermined constant related to a delay.

### (Sixth Item)

The control device according to any one of the first to fifth items, wherein the policy information calculation unit determines surrounding conditions of the moving body from an image captured by a camera mounted on the moving body.

### (Seventh Item)

The control device according to any one of the first to sixth items, wherein the policy information is information indicating a frame rate of the camera according to the quality of the network, the control execution unit determines the frame rate according to the acquired quality of the network on the basis of the policy information and controls the camera such that the camera acquires an image at the determined frame rate.

### (Eighth Item)

A control method executed by a control device for controlling a moving body in a system of monitoring the moving body from a remote location via a network, the control device including a policy database configured to store policy information for controlling the moving body, the control method including a policy information calculation step of calculating policy information indicating details of control according to a quality of the network on the basis of surrounding conditions of the moving body and storing the policy information in the policy database, and a control execution step of acquiring the quality of the network and executing control corresponding to the quality of the network with reference to the policy information.

### (Ninth Item)

A program causing a computer to function as each part of the control device according to any one of the first to seventh items.

Although the present embodiment has been described above, the present invention is not limited to such a specific embodiment and various modifications and changes can be made within the scope of the gist of the present invention described in the claims.

This patent application claims its priority on the basis of the international patent application PCT/JP2020/016731 filed on Apr. 16, 2020, and the entire contents of the international patent application PCT/JP2020/016731 are incorporated in the present application.

### REFERENCE SIGNS LIST

10 Moving body
100 Control device
200 NW information collecting device
300 Regulatory information storage device
400 Monitoring control device
500 Network
110 Policy value calculation unit
111 Image acquisition unit
112 Host vehicle condition acquisition unit
113 Surrounding condition calculation unit
114 Stopping distance regulation acquisition unit
120 Policy DB
130 Policy management unit
140 Information acquisition unit
150 Action management unit
160 NW information receiving unit
170 Camera
1000 Drive device
1001 Recording medium
1002 Auxiliary storage device
1003 Memory device
1004 CPU
1005 Interface device
1006 Display device
1007 Input device
1008 Output device

1. A control device for controlling a moving body in a system of monitoring the moving body from a remote location via a network, the control device comprising:
a policy database configured to store policy information for controlling the moving body; and
one or more processors configured to execute instructions that cause the one or more processors to:
calculate the policy information indicating details of control according to a quality of the network on a basis of surrounding conditions of the moving body and to store the policy information in the policy database; and
acquire the quality of the network and to execute control corresponding to the quality of the network with reference to the policy information.

2. The control device according to claim 1, wherein
the policy information is information indicating a speed of the moving body according to the quality of the network, and the instructions cause the one or more processors to determine a speed according to the acquired quality of the network on a basis of the policy information and controls the moving body such that the moving body travels at the determined speed.

3. The control device according to claim 1, wherein
the instructions cause the one or more processors to calculate, as the policy information, a speed at which the moving body is able to stop within a specified stopping distance for each quality of the network when an observer instructs the moving body to stop from a remote location.

4. The control device according to claim 1, wherein,
when a round-trip network delay as the quality of the network exceeds a threshold value, the instructions cause the one or more processors to calculate a speed of the moving body after deceleration using a turn around time (TAT) to which a jitter has been added and controls the moving body such that the moving body travels at the calculated speed.

5. The control device according to claim 4, wherein
the instructions cause the one or more processors to calculate the threshold value using the jitter, the specified stopping distance, the speed of the moving body, a friction coefficient, and a predetermined constant related to a delay.

6. The control device according to claim 1, wherein
the instructions cause the one or more processors to determine surrounding conditions of the moving body from an image captured by a camera mounted on the moving body.

7. The control device according to claim 1, wherein
the policy information is information indicating a frame rate of the camera according to the quality of the network, and the instructions cause the one or more processors to determine the frame rate according to the acquired quality of the network on a basis of the policy information and controls the camera such that the camera acquires an image at the determined frame rate.

8. A control method executed by a control device for controlling a moving body in a system of monitoring the moving body from a remote location via a network, the control device including a policy database configured to store policy information for controlling the moving body, the control method comprising:
calculating policy information indicating details of control according to a quality of the network on a basis of surrounding conditions of the moving body;
storing the policy information in the policy database; and
acquiring the quality of the network and executing control corresponding to the quality of the network with reference to the policy information.

9. A non-transitory computer-readable medium storing program instructions that, upon execution, cause a computer to perform operations comprising:
calculating policy information indicating details of control according to a quality of a network on a basis of surrounding conditions of a moving body;
storing the policy information in a policy database; and
acquiring the quality of the network and executing control corresponding to the quality of the network with reference to the policy information.
